(19) United States
(12) Patent Application Publication
(10) Pub. No.: US 2012/0210804 A1
(43) Pub. Date: Aug. 23, 2012

(54) SOLID ALIQUOTS OF MULTIRESIDUE METHOD SALTS FOR SOLID PHASE EXTRACTION APPLICTIONS

(76) Inventors: Neil H. Mosesman, Mount Joy, PA (US); Brian A. Jones, Bellefonte, PA (US); Jack W. Cochran, State College, PA (US)

(21) Appl. No.: 13/138,891

(22) PCT Filed: Apr. 16, 2010
(86) PCT No.: PCT/US10/01131

§ 371 Date: May 1, 2012

Related U.S. Application Data
(60) Provisional application No. 61/214,102, filed on Apr. 18, 2009.

(51) Int. Cl. G01N 1/34; B01J 20/00

(52) U.S. Cl. 73/863.21; 502/400

(57) ABSTRACT

It is an object of the invention to improve the current QuEChERS technology. In one aspect of the invention, the buffer-salt powder mixture of the first stage of the QuEChERS process is compressed into a solid dosage form before it is used in the first stage of the QuEChERS process. Replacing the QuEChERS powders (the buffer-salt powder mixture of the first stage of the QuEChERS process) with solid aliquots eliminates the need for using centrifuge tubes for packaging the product.

QuEChERS method, which stands for quick, easy, cheap, effective, rugged, and safe (pronounced “catchers”) is an extraction and cleanup method based on research by the US Department of Agriculture Eastern Regional Research Center in Wyndmoor, Pa.^{[1,2]}. Researchers there were looking for a simple, effective, and inexpensive way to extract pesticide residues from the many varied sample matrices with which they routinely worked and subsequently clean up those extracts prior to analysis. Prior to QuEChERS the researchers had been using the Modified Luke Extraction Method^{[3]}, which is effective and rugged, but is both labor and glassware intensive, leading to a relatively high cost per sample. Solid phase extraction cleanup also had been effective, but the complex matrices the investigators were dealing with required multiple individual cartridges and sorbents to remove the many classes of interferences, adding costs and complexity to the process. A new method would have to remove sugars, lipids, organic acids, sterols, proteins, pigments and excess water, any of which often may be present, but still be easy to use and inexpensive.

Currently, two officially recognized QuEChERS extraction methods are published, AOAC and prEN, which are briefly described below. For both the AOAC and prEN QuEChERS methods, products which include the sample extraction power mix added in the sample extraction stage of the methods are available from Restek as well as several other suppliers ^{[4-7]}. The prEN 15662 method employs magnesium sulfate and citrate salts with acetonitrile and is a preferred extraction method demonstrated in this application. Alternatively, the AOAC method (which uses magnesium sulfate and sodium acetate as extraction salts), as well as future equivalent methods, may be used, in accordance with the invention.

The prEN 15662 QuEChERS extraction method employs a simple two-stage procedure:

### 1. Sample Extraction Stage.

Sample is homogenized, preferably with a food chopper or blender.

10 g of homogenized sample is weighed into a 50 mL centrifuge tube.

10 mL of acetonitrile is added to the sample in the centrifuge tube. Also, an internal standard may be added at this point.

The tube is shaken vigorously for 1 minute.

A buffer-salt mixture then is added to the tube.
The prEN 15662 buffer-salts are:
   4 g anhydrous magnesium sulfate,
   1 g sodium chloride,
   1 g trisodium citrate dihydrate,
   0.5 g disodium hydrogencitrate sesquihydrate

The tube is capped and shaken immediately after salt addition to break any lumps forming from magnesium sulfate addition.

Then, the tube is shaken vigorously, partitioning the acetonitrile away from the aqueous portion of the sample.

Next, the tube is centrifuged for 5 minutes, which produces an acetonitrile supernatant containing the analytes of interest.

### 2. Sample Cleanup Stage.

The acetonitrile supernatant resulting from the sample extraction stage of the PrEN 15662 method is cleaned, using a dispersive solid-phase extraction (dSPE) technique. There are currently two prEN 15662 formats for dSPE, 2 mL and 15 mL centrifuge tubes containing magnesium sulfate and sorbents as listed below:
Standard 2 mL prEN 15662 mixtures may contain:
   150 mg anhydrous magnesium sulfate, to partition water from organic solvent,
   25 mg primary and secondary amine (PSA) exchange material adsorbent ^{[8,10]}, to remove sugars and fatty acids, and/or:
   2.5 or 7.5 mg graphitized carbon black, to remove pigments and sterols, and/or:
   25 mg C18, to remove nonpolar interferences, including lipids.
Standard 15 mL prEN 15662 mixtures may contain:
   900 mg anhydrous magnesium sulfate, to partition water from organic solvent,
   150 mg primary and secondary amine (PSA) exchange material adsorbent ^{[8,10]}, to remove sugars and fatty acids, and/or:
   15 or 45 mg graphitized carbon black, to remove pigments and sterols, and/or:
   150 mg C18, to remove nonpolar interferences, including lipids.

Either 1 mL of the acetonitrile supernatant (if using the 2 mL centrifuge tube format) or 6 mL of the acetonitrile supernatant (if using the 15 mL centrifuge tube format) is added to the tube containing the salt/sorbent mixture.

The tube is shaken for 30 seconds (or 2 minutes when using graphitized carbon black).

Then, the tube is centrifuged for 5 minutes to produce a clear/clean extract ready for gas chromatographic and/or liquid chromatographic analysis. The extract may be acidified prior to analysis.

Validation and proficiency data for the QuEChERS method are available^{[11,12}] for a wide variety of pesticides in several common food matrices.

The AOAC QuEChERS extraction method is very similar to the prEN 15662 method and also employs a two-stage procedure:

### 1. Sample Extraction Stage.

Sample is homogenized, preferably with a food chopper or blender.

15 g of homogenized sample is weighed into a 50 mL centrifuge tube.

15 mL of acetonitrile with 1% acetic is added to the sample in the centrifuge tube. Also, an internal standard may be added at this point.

A buffer-salt mixture is added to the tube.
The AOAC buffer-salts are:
   6 g anhydrous magnesium sulfate,
   1.5 g anhydrous sodium acetate

The tube may be capped and shaken immediately after salt addition to break any lumps forming from magnesium sulfate addition.

Then, the tube is shaken vigorously for 1 minute.

Next, the tube is centrifuged for 1 minute, which produces an acetonitrile supernatant containing the analytes of interest.

### 2. Sample Cleanup Stage.

The acetonitrile supernatant resulting from the sample extraction stage of the AOAC method is cleaned, using a dispersive solid-phase extraction (dSPE) technique. There are currently two AOAC formats for dSPE, 2 mL and 15 mL centrifuge tubes that may contain magnesium sulfate and sorbents as listed below:
Standard 2 mL AOAC mixtures may contain:
   150 mg magnesium sulfate, to partition water from organic solvent,
   50 mg primary and secondary amine (PSA) exchange material adsorbent ^{[8,10}], to remove sugars and fatty acids, and/or:
   50 mg graphitized carbon black, to remove pigments and sterols, and/or:
   50 mg C18, to remove nonpolar interferences, including lipids.
Standard 15 mL prEN 15662 mixtures may contain:
   1200 mg magnesium sulfate, to partition water from organic solvent,
   400 mg primary and secondary amine (PSA) exchange material adsorbent ^{[8,10}], to remove sugars and fatty acids, and/or:
   400 mg graphitized carbon black, to remove pigments and sterols, and/or:
   400 mg C18, to remove nonpolar interferences, including lipids.

Either 1 mL of the acetonitrile supernatant (if using the 2 mL centrifuge tube format) or 8 mL of the acetonitrile supernatant (if using the 15 mL centrifuge tube format) is added to the tube containing the salt/sorbent mixture.

The tube is shaken for 30 seconds.

Then, the tube is centrifuged for 1 minute to produce a clear/clean extract ready for gas chromatographic and/or liquid chromatographic analysis.

### Current Technology: Plastic Tubes

The buffer-salt mixture used in the first stage of the QuEChERS process and the salt/sorbent mixture used in the second stage of the QuEChERS process are sold in powder form where the subcomponents are combined in the appropriate molar weight ratios. These mixtures are sold in either bulk format or as preweighed aliquot powder volumes. The standard packaging of pre-weighed extraction aliquot powder (the buffer-salt powder mixture of the first stage of the QuEChERS process) volumes are plastic tubes, for example 50 mL centrifuge tubes.

The QuEChERS process recommends the order of addition in the first stage of the process be
(1) add the homogenized sample to an empty tube
(2) add acetonitrile (prEN 15662) or acetonitrile/1% acetic acid (AOAC)
(3) add extraction/buffer salts.

Because the buffer-salt powder mixture is supplied in a ready vessel for the analysis, the homogenized samples and acetonitrile can be mistakenly added directly to the tube containing the buffer-salt powder mixture, thereby combining the three addition steps of first stage of the process rather than sequentially doing the steps of the first stage of the process. This may result in lumping of the magnesium sulfate and subsequent poor partitioning of the sample and erroneous analysis data. Alternatively, the analytical chemist may use a second empty tube and subsequently transfer the QuEChERS powder in the third step. In this fashion there is a risk of incomplete transfer as the powder tends to adhere to the tubes due to static, or remain trapped in the threads of the first tube, or be partially spilled during transfer. Transferring the powder to a second tube also may double the amount of plasticware waste, which is undesirable from an environmental perspective.

### SUMMARY OF THE INVENTION

It is an object of the invention to improve the current QuEChERS technology. In one aspect of the invention, the buffer-salt powder mixture of the first stage of the QuEChERS process is compressed into a solid dosage form before it is used in the first stage of the QuEChERS process. Replacing the QuEChERS powders (the buffer-salt powder mixture of the first stage of the QuEChERS process) with solid aliquots eliminates the need for using centrifuge tubes for packaging the product. A tablet allows for easier application of the QuEChERS products to the recommended methods protocols in the correct order. A solid aliquot form of the QuEChERS products also enables aggregate packaging, i.e., multiple premeasured tablets in a single storage container or roll. Tablets inherently permit multiple premeasured aliquots to be in physical contact without the risk of product mixing. Packaging multiple tablets also further reduces packaging waste.

### DESCRIPTION OF THE INVENTIONS

We present here an improvement to the current QuEChERS technology, where in accordance with the invention the buffer-salt powder mixture is compressed into a solid dosage form before use in the first stage of the process.

As used herein the term “solid dosage form” is intended to refer to a presentation which is suitable in particular for addition to a sample solution being prepared for extraction and has any desired forms such as, for example, tablets, coated tablets, pastilles, pellets, granules and the like. Tableting technology has been used extensively in the pharmaceutical^{[13-16]} detergents^{[17-19]} and water treatment/sterilization industries^{[17-19]} for many years. The term “tablet” is well understood by not only those skilled in the art but is sufficiently familiar to the general public at large.

In a preferred first embodiment of the invention, the components of the standard QuEChERS powders (the buffer-salts) are directly compressed into a tablet. Preferably, the components are first mixed together to form a buffer-salt powder mixture. Generally, the term “tablet” includes not only tablets per se but also similar discrete bodies, or bodies of other shapes and sometimes known by different names, such as “caplets” (e.g. capsule-shaped tablets). As used herein, the term is also used to refer to mixtures of particulate solid materials, which have been brought together in various ways and finally compressed using one or more apparatus known to those skilled in the art so that the active substances become compacted into shaped entities able to persist under normal handling conditions but disintegrate at the desired site, time or combination of both. In this invention the composition of the tablet represents 100% active ingredients.

Preferably, the buffer-salt components of the AOAC method comprise anhydrous magnesium sulfate (preferably 6 grams) and anhydrous sodium acetate (preferably 1.5 grams).

Preferably, the buffer-salt components of the prEN method comprise anhydrous magnesium sulfate (preferably 4 grams), sodium chloride (preferably 1 gram), trisodium citrate dehydrate (preferably 1 gram), and disodium hydrogencitrate sesquihydrate (preferably 0.5 grams).

In a preferred second embodiment of the invention, the components of the standard QuEChERS powders are replaced at least in part with ionic analogues in an effort to (1) improve the desired properties of the tablet, such as mechanical stability, chemical stability, and shelf life, (2) improving the tablet performance upon administration to the sample, such as fast solubility and integration with the sample, and (3) maintain the final ionic concentrations of the standard QuEChERS powders in the sample solution. In this case the tablet remains 100% active ingredient.

In preferred third embodiment of the invention the components of the standard QuEChERS powders are combined with additional agents directed towards improving the desired properties of producing the tablet, such as mechanical stability, chemical stability, and shelf life, as well as improving the tablet performance upon administration to the sample, such as fast solubility and integration with the sample.

Typically, tablets contain an active ingredient, an excipient such as a bulking agent, a binder to hold the tablet together, a disintegrant to promote the breaking-up of the tablet after ingesting and to release the medicine, and a lubricant to prevent the tablet from sticking to the tablet-punch. Additionally, the tablet may be coated with an inert material to improve appearance or improve shelf life of the tablet. In this case the tablet is less than 100% active ingredient. In the case of the QuEChERS analytical process three additional specifications of the tablet additives are desirable:
1. Preferably, all components originating from the capsule itself reside in the polar portion of the liquid separation.
2. Preferably, have negligible negative impact on the extraction.
3. Preferably, have negligible impact on the lifetimes of the GC column or GC inlet elements.

In accordance with this embodiment of the invention, preferable tablet additives include excipients such as bulking agents, and/or binders, and/or disintegrants, and/or lubricants. Further, the tablets of the invention may be coated with an inert material.

In preferred fourth embodiment of the invention, the components of the standard QuEChERS powders are enclosed in a capsule or other soluble vessel. Because the vessel becomes integrated with the sample extraction process it must also meet the additional specifications of the tablet additives listed above for the third embodiment of the invention.

In a preferred fifth embodiment of the inventionₛ the components of the standard QuEChERS powders are enhanced with the addition of internal standards relevant to the sample analysis and subsequently compressed into a solid dosage form, or the solid dosage form is created first and then the internal standards are added to the solid dosage. In this case the purpose of the tablet additives goes beyond the original purpose of sample extraction. Internal standards must remain consistent with respect to the amount of standard originally added to the tablet and the amount finally resident in the sample extraction solution during use. Standard candidates preferably therefore meet the following criteria in order to be suitable:
1. Stable with respect to the other components of the tablet.
2. Stable with respect to shelf life.

In cases where candidate standards do not exhibit suitable performance with respect to these criteria, encapsulation technology similar to those described in the third embodiment of the invention may also be employed. Stabilizing additives such as Tenax or other sorbants may also be employed.

Experiment I: QuEChERS Extractions with Current Methodology Vs. Sample Extraction Tablet Method.

### Control QuEChERS Product:

Restek Resprep Model #Q110 (Cat.#26213) employing prEN 15662 method extraction salts.

### QuEChERS Solid Aliquot Tablets 1-3:

Tablet composition: (prEN-specific) extraction salts:
4 g magnesium sulfate
1 g sodium chloride
1 g trisodium citrate dihydrate
0.5 g disodium hydrogencitrate sesquihydrate

Dry pressed at Restek to ca. 1,500 p.s.i. using laboratory built hydraulic press apparatus similar to commercially available technology ^{[13]}.

### Sample:

Beech-Nut Stage 2® Apples & Blueberries; 4 oz jar baby food (Hero/Beech-Nut international, Lenzburg, Switzerland)

Sample was spiked with organochlorine pesticides standard

Restek Organochlorine Pesticide Mix AB #1 (Cat# 32291)

Restek Organochlorine Pesticide Mix AB #1 (Cat# 32291) composition:
Aldrin
Hexachlorocyclohexanes
Chlordanes
4,4′-DDE
4,4′-DDD
4,4′-DDT
Dieldrin
Endosulfans
Endosulfan sulfate
Endrin
Endrin aldehyde
Endrin ketone
Heptachlor
Heptachlor epoxide
Methoxychlor

Final concentration in baby food sample: 200 ppb

Current prEN 15662 QuEChERS Method:

Step 1.

Sample homogenization (baby food is already homogenized).
10 g sample, 10 mL acetonitrile
Shake for 1 min

Step 2.

Buffer salt addition [1 sample: Restek Resprep Q110; 3 samples: prototype tablet].
4 g magnesium sulfate
1 g sodium chloride
1 g trisodium citrate dihydrate
0.5 g disodium hydrogencitrate sesquihydrate

Step 3.

Shake again for 1 min.

Step 4.

Centrifuge for 5 min.

Step 5.

Aliquot shot on GC for analysis.

Tablet prEN 15662 QuEChERS Method:

Step 1.

Sample homogenization (baby food is already homogenized).
10 g sample, 10 mL acetonitrile
Shake for 1 min

Step 2.

Add tablet to mixture

Step 3.

Shake again for 1 min.

Step 4.

Centrifuge for 5 min.

Step 5.

Aliquot shot on GC for analysis.

### Tablet Production

Prototype tablets were produced using conventional 2-piston compression techniques^{[13}]. Preweighed aliquots of the standard QuEChERS power (Restek Resprep Model #Q110; Cat.#26213) were loaded into a laboratory-built compression tableting vessel and compressed with ca. 1,500 p.s.i. and a hold time of less than 1 minute.

Preferably the components of the tablet include but are not limited to:
magnesium sulfate
sodium chloride
trisodium citrate dihydrate
disodium hydrogencitrate sesquihydrate

TABLE 1
Physical characteristics of sample extraction tablets

| | Sample | Weight | Diameter | Height |
|---|---|---|---|---|
| Tablet # | prep stage | (g) | (mm) | (mm) |
| 1 | Stage 1, | 5.4 | 21 | 9 |
| | Extraction | | | |
| 2 | Stage 1, | 4.8 | 21 | 8 |
| | Extraction | | | |
| 3 | Stage 1, | 5.6 | 21 | 11 |
| | Extraction | | | |

GC Conditions:
13.5m×0.25mm×0.25 μm Rxi-5 MS
One μL splitless injection at 250° C.
1 mL/min He, constant flow
80° C. (1 min), 30°/min to 130°, 15°/min to 320° C.
Electron capture detector
350° C.
Nitrogen makeup gas 49 mL/min
   Experiment I: Results

### Experiment I: Conclusions

The “No Tablet” and “Tablet” chromatograms of organochlorine pesticides extracted from baby food are essentially identical.

These chromatograms were very close to standard chromatograms.

Recoveries of organochlorine pesticides were comparable between the standard powder method and the tablet method.

### Experiment II: Standard Addition of Tetrachloro-m-xylene and Decachlorobiphenyl to the Tablet.

In this experiment tetrachloro-m-xylene and decachlorobiphenyl are added to the tablet as internal standards.

Experimental conditions are the same as for Experiment I, however prior to step 1 two additional standards, tetrachloro-m-xylene and decachlorobiphenyl were administered dropwise directly to the SPE tablet. Given the volatile nature of some of the standards components three experimental conditions were tested.

TABLE 2
Three more tablets were prepared from the standard QuEChERS powders.
Physical characteristics of sample extraction tablets, second manufactured lot.

| | | | | | Internal Standard Addition |
|---|---|---|---|---|---|
| | | | | | Tetrachloro-m-xylene and |
| | Sample | | | | decachlorobiphenyl |
| | prep | Weight | Diameter | Height | 200 ppb final concentration each |
| Tablet # | stage | (g) | (mm) | (mm) | compound |
| 4 | Stage 1, | 8.1 | 21 | 12 | Added to Tablet #4 17 hours before |
| | Extraction | | | | extraction, stored in a capped 50 mL |
| | | | | | centrifuge tube in the laboratory |
| | | | | | overnight |
| | | | | | 124 μL drop-wise on tablet |
| 5 | Stage 1, | 8.5 | 21 | 14 | Added to Tablet #5 immediately (>30 |
| | Extraction | | | | seconds) before extraction |
| | | | | | 130 μL drop-wise on tablet |
| 6 | Stage 1, | 5.8 | 21 | tablet | (Control) Added to acetonitrile and |
| | Extraction | | | capping | baby food mixture directly for Tablet |
| | | | | occurred, no | #6 |
| | | | | height | 90 μL. Liquid standard was added via |
| | | | | measurement | syringe beneath the liquid level of the |
| | | | | available | mixture. |

### Experiment II: Conclusions

As expected, the relatively volatile tetrachloro-m-xylene was significantly lost from the surface of the tablet after storage for 17 hours.

Less volatile decachlorobiphenyl however showed approximately the same response for 17 hour and “immediately before” tablets.

Tablet failure modes. Tablet #6 exhibited physical separation of the tablet into two pieces. This condition is known as capping or laminating to those skilled in the art of tablet manufacture. Further, tablet #s 4 and 5 exhibited greater hardness properties as compared to previous tablets. Because the standard QuEChERS salts employ a combination of hydrate and anhydrous crystalline forms it is possible for solid-solid interaction and reaction to occur during the compression phase of the tabletting process ^{[23,24]}.

The presence of hydrous MgSO4 and citrate salts together, intimately mixed and subjected to pressure, allows for the formation of Mg citrate with a different solubility and crystal structure that desires a different hydration level than the starting MgSO4. This process frees up water molecules to further solubilize the salts and continue the reaction. While this process may be desirable from a tablet forming/binding perspective, it can explain the strong bonding of the freshly formed tablet to the metal surface of the die, with the observed “liquid-like” flow of some material past the very closely toleranced piston and sleeve walls.

As the overall processes are facilitated by the presence of the water of crystallization in the various salts, it follows that control of the flow under hydraulic pressure may be obtained by the drying of some or all of the salts to a lower hydrous level before compacting, greatly reducing the difficulties of tablet forming. While this may impact the compression strength of the tablet initially, exposure of the freshly formed and extruded composite to a controlled environment of highly humidified air (or water mist spray) for a fixed period of time may allow the formation of a hydrous stabilizing skin on its surface, reducing friability of the finished product, but not limiting the dissolution rate at the point of use by the customer.

The references referred to in this application and listed below are hereby incorporated herein by reference.

### REFERENCES

[1] M. Anastassiades, S. J. Lehotay, D. Stajnbaher, F. J. Schenck Fast and Easy Multiresidue Method Employing Acetonitile Extraction/Partitioning and “Dispersive Solid-Phase Extraction” for the Determination of Pesticide Residues in Produce, J. AOAC Int., 86 (2003) 412-431.
[2] R. E. Majors; QuEChERS—A New Technique for Multiresidue Analysis of Pesticides in Foods and Agricultural Samples; chromatographyonline.com; Nov. 1, 2007. http://chromatographyonline.findanalytichem.com/lcqc/article/articleDetail.isp?id=473128&sk=&date=&pageID=5
[3] C. Díeza, W. A. Traagb, P. Zommerb, P. Marineroa and J. Atienzaa; “Comparison of an acetonitrile extraction/partitioning and “dispersive solid-phase extraction” method with classical multi-residue methods for the extraction of herbicide residues in barley samples” Journal of Chromatography A; Volume 1131, Issues 1-2, 27 (2006), 11-23.
[4] USDA website, “QuEChERS Methods Catches Pesticide Residues”; http://www.ars.usda.govfis/AR/archive/jul03/quech0703.htm
[5] Restek website, “Restek QuEChERS Products”; http://www.restek.com/quechers/; http://www.restek.com/restek/images/external/580141.pdf
[6] Sigma-Aldrich web site; http://www.sigmaaldrich.com/analytical-chromatoqraphy/sample-preparation/spe/dispersive-spe-tubes.html
[7] UCT, Inc. website, http://www.unitedchem.com/product.aspx?P=30; http://www.unitedchem.com/sitefiles/productdownload1/Quechers%202008.pdf
[8] Chromtech catalog; Varian Bond Elut—Anion Exchange SPE Columns; (c) 2001, pp. 126; http://www.chromtech.com/2001catalog/SeparatePqs/126.pdf
[9] Varian website; Packed Bed: Anion Exchange, Bond Elut.; http://www.varianinc.com/cgi-bin/nav?products/consum/samprep/spe/packed/anion/psa&cid=JJHJOKIHFQ
[10] Method Development in Solid Phase Extraction using Polar ISOLUTE® SPE Sorbents for the Extraction of Non-Aqueous Samples; Technical Note 102 (TN102 rev1.3); Argonaut Technologies, Inc.; http://www.teknolab.no/pdf/IST_SPE_Method_Development_Using_Polar_Isolute_Non_Aqueous_Samples.pdf
[11] “QuEChERS—Mini-Multiresidue Method for the Analysis of Pesticides”; Michelangelo Anastassiades, CVUA Stuttgart; http://www.quechers.com/docs/quechers_en_oct2005.pdf
[12] “Validation data forQuEChERS”; Michelangelo Anastassiades, CVUA Stuttgart; http://www.quechers.com/docs/valid_data_{—}2rt.pdf
[13] J. Swarbrick, J. C. Boylan, ed.; Encyclopedia of Pharmaceutical Technology, 2^{nd} edition, vol. 3; © 2002, pp 2713-2731.
[14] U.S. Pat. No. 4,632,843 C. H. Pich, T. Moest; “Process for the preparation of solid pharmaceutical products”
[15] U.S. Pat. No. 6,596,311; L. Dobetti; “Fast disintegrating tablets”
[16] International Patent WO/2006/047067; J. YUAN, N. M. CLIPSE, S. H.-W. WU; “TABLETS COMPRISING A POORLY COMPRESSIBLE ACTIVE AGENT AND TOCOPHEROL POLYETHYLENEGLYCOL SUCCINATE (TPGS)”
[17] U. Zoller (ed.), P. Sosis (ed.) Handbook of Detergents, Part F: Production; (c) 2008; chapter 19.
[18] U.S. Pat. No. 4,642,197; H. Kruse, K. Koester, F.-J. Carduck, H.-M. Wilsberg, R. Puchta; Process for the production of a washing additive in tablet form”
[19] U.S. Pat. No. 5,358,655; H. Kruse, C. Zeise, J. Jacobs, J. Haerer “Process for the production of detergent tablets for dishwashing machines”
[20] U.S. Pat. No. 6,984,398; J. P. Brennan, P. S. Loomis; “Calcium hypochlorite blended tablets”
[21] U.S. Pat. No. 6,965,035; J. N. Howarth, B. J. Peters; “Compacted forms of halogenated hydantoins”
[22] U.S. Pat. No. 7,018,562; S. Morioka, Y. Iwasaki, Y. Seo; “Compression molded product of quick-dissolving chlorinated isocyanuric acid”
[23] R. Hilfiker, (ed.); Polymorphism in the Pharmaceutical Industry; pp. 333-361 (c) 2006.
[24] U.S. Pat. No. 2,260,004; J. L. Davenport, C. F. De Costa; “Stable Soluble Magnesium and Citrate”

1. A solid dosage form of buffer-salts for use in the first stage of the QuEChERS process, comprising a buffer-salt mixture, and optionally any, some, or all of the following components: a bulking agent, a binder, a disintegnant, and/or a lubricant.

2. The solid dosage form of claim 1,
the buffer-salt mixture being replaced at least in part with ionic analogues.

3. The solid dosage form of claim 1, including internal standards.

4. A capsule of buffer-salts for use in the first state of the QuEChERS process, comprising
a hollow vessel, and
a buffer-salt mixture held within the hollow vessel.

5. The capsule of claim 4, the vessel being soluble.

6. A method of extracting pesticide residues from a sample and subsequently cleaning those extracted pesticide residues for analysis, comprising the steps of
adding an homogenized sample to an empty tube,
adding acetonitrile or acetonitrile/acetic acid into the sample to form a mixture in the tube,
mixing a solid dosage form or capsule of buffer-salts into the mixture in the tube,
centrifuging the tube to produce an acetonitrile supernatant, and
cleaning the acetonitrite supernatant to produce an extract ready for analysis.

7. The method of claim 6,
the solid dosage form comprising a buffer-salt mixture, and optionally any, some, or all of the following components: a bulking agent, a binder, a disintegnant, and/or a lubricant.

8. The method of claim 6,
the capsule comprising a hollow vessel, and
a buffer-salt mixture held within the hollow vessel.

9. The method of claim 8,
the vessel being soluble.

10. The method of claim 6,
the buffer-salt mixture being replaced at least in part with ionic analogues.

11. The method of claim 6, further including adding internal standards to the solid dosage form or to the buffer-salts.

12. A solid dosage form of buffer-salts for use in the first stage of the QuEChERS process, as shown and described herein.

13. A method of extracting pesticide residues from a sample and subsequently cleaning those extracted pesticide residues for analysis, as shown and described herein.
